(19) United States
(12) Patent Application Publication
(10) Pub. No.: US 2022/0234947 A1
(43) Pub. Date: Jul. 28, 2022

(54) A 3D STRUCTURE FOR EASY-TO-CLEAN COATINGS

(71) Applicant: Corning Incorporated, Corning, NY (US)

(72) Inventors: Kaveh Adib, Corning, NY (US); Theresa Chang, Painted Post, NY (US); Sean Patrick Coleman, Lindley, NY (US); Jiangwei Fei, Painted Post, NY (US); Ying Wei, Painted Post, NY (US); Christine Coulter Wolcott, Horseheads, NY (US); Shu Yuan, Horseheads, NY (US); Binwei Zhang, Horseheads, NY (US); Chunhe Zhang, Hickory, NC (US)

(21) Appl. No.: 17/610,048

(22) PCT Filed: May 13, 2020
(86) PCT No.: PCT/US2020/032628

§ 371 Date: Nov. 9, 2021

Related U.S. Application Data
(60) Provisional application No. 62/847,528, filed on May 14, 2019.

(51) Int. Cl. C03C 17/30; C09D 183/06

(52) U.S. Cl. CPC C03C 17/30; C09D 183/06; C03C 2217/732; C03C 2217/76; C08G 77/70; C03C 2218/112; C03C 2218/152; C03C 2218/32; C03C 2218/116

(57) ABSTRACT

Various embodiments provide an article including a substrate and a coating thereon including a functionalized fluorine containing compound crosslinked with a multifunctional siloxane resin. A method of forming the article includes applying a multifunctional siloxane resin to a substrate, applying a functionalized fluorine containing compound to the substrate, and annealing the multifunctional siloxane resin and the functionalized fluorine containing compound.

### CROSS-REFERENCE TO RELATED APPLICATIONS

This application claims the benefit of priority under 35 U.S.C. § 119 of U.S. Provisional Application Ser. No. 62/847,528 filed on May 14, 2019 the content of which is relied upon and incorporated herein by reference in its entirety.

### BACKGROUND

Chemically strengthened glass is used on more than five billion devices as a user interface for touch screens. These devices include handheld devices and automotive displays, among other consumer products. For automotive displays, optical clarity and strength with thinner aspect ratios are important for fuel economy and low weight.

Generally, these types of glass are treated for both aesthetics and functional purposes. For example, anti-reflective, anti-glare, and anti-fingerprint coatings or treatments are often applied. In the context of automotive applications, these coatings must last longer than on consumer electronics.

Anti-fingerprint coatings, also referred to as “easy-to-clean” (ETC) coatings, repel materials from the surface of the glass substrate; for example, water, dust, and environmental debris, in addition to sebum, including oils and proteins. The surface of ETC coatings should retain performance even with repeated abrasion by use, swiping, or cleaning.

Under cheese cloth abrasion durability testing, current ETC coatings fail to maintain a water contact angle above 100 degrees with 200 k cycles. In particular, current standard ETC coatings cannot meet this requirement when used in conjunction with other glass treatments for optics, such as anti-reflective (AR) coatings.

ETC coatings are commonly made of fluorinated materials with silane moieties. In current ETC coatings, the silane moeities bind to the surface of the substrate as monolayers and have a thickness in the range of 2 nm to 5 nm. Thus, once the nanoscale surface coating is abraded and the monolayer of silane moeties disrupted, the surface no longer retains the desired ETC properties.

### SUMMARY OF THE DISCLOSURE

Disclosed herein are an article and process of making that article with an easy-to-clean (“ETC”) coating located on a surface of an article. The ETC coating can include a functionalized fluorine containing compound crosslinked with a multifunctional siloxane resin. The article can include a siloxane primer on the substrate, the primer chemically linking to the ETC coating.

The disclosed article can have enhanced abrasion resistance, as a multilayered crosslinked structure with self-contained friction modifier. The disclosed methods can be a more efficient use of high cost perfluoroether silane materials, as often the excess fluorinated materials are either unbound or easily removed prior to and during use, and can increase capacity for covalently bound active components.

The method can allow for surface property recovery of the substrate, as a perfluoroether silane material embedded in the coating can act as a reservoir that could be revealed upon abrasion. The coating can have lowered surface process sensitivity, as reactive groups can be heat-activated and therefore less susceptible to hydrolytic degradation.

Unlike monolayer coatings, it is possible to incorporate other additives, such as light stabilizers to improve resistance to UV degradation. The discussed methods can be used with a large variety of silane based coatings.

The use of a siloxane primer on the substrate prior to application of the ETC coating, such as an organosiloxane primer, which can adhere well to glass and glass ceramic substrates and can allow for the ability to tune the surface chemistry of the primer so that appropriate chemistry can be provided on various substrates for improved performance of silane-ETC coatings. This can be done, for example, by using inorganic silicon oxide thin films.

Moreover, processing polysiloxane coatings can be more cost effective than alternatives, such as vacuum applied coatings. In contrast, polysiloxane coatings can be applied, for example, using in-line processes such as spraying which can have lower capital cost and a lower cost of use. Additionally, plasma units can be used for cleaning substrates prior to primer application, and also to cure and activate the primer.

In various embodiments, an article includes a substrate and a coating thereon comprising a functionalized fluorine containing compound crosslinked with a multifunctional siloxane resin.

In various embodiments, a method of making an article includes applying a multifunctional siloxane resin to a substrate, applying a functionalized fluorine containing compound to the substrate, and annealing the multifunctional siloxane resin and the functionalized fluorine containing compound.

In some embodiments, the coating has increased abrasion resistance due to a multilayered crosslinked structure with a self-contained friction modifier.

In some embodiments, the coatings are a more efficient use of high cost perfluoroether silane materials. In some embodiments, the coatings have an increase in capacity for covalently bound active component.

In some embodiments, the cost is lowered by dilution with oxide crosslinker and potential for lower material usage.

In some embodiments, the coatings can have a surface property recovery, as the perfluoroether silane material embedded in the resin acts as a reservoir that could be revealed upon abrasion.

In some embodiments, the coating can have lowered surface process sensitivity, due to the use of a multifunctional crosslinker. Some multifunctional crosslinkers have reactive groups that are heat activated and therefore less susceptible to hydrolytic degradation.

In some embodiments, it is feasible to incorporate other additives, such as light stabilizers to improve resistance to UV degradation.

In some embodiments, the multifunctional siloxane resin can act as a planarizing layer and reduce surface roughness of the coating while improvising abrasion resistance.

In some embodiments, the porosity and modulus of the coating are reduced relative to the substrate.

In some embodiments, the multifunctional siloxane resin increases crosslinking in the coating.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic diagram of a single-layer ETC on an anti-reflective (AR) glass without crosslinking.

FIG. 2 is a schematic diagram of a multifunctional siloxane resin functionalized with an ETC coating on an AR glass.

FIG. 3 is a graphical illustration of the static water contact angle of substrates with a siloxane primer and an ETC coating.

FIG. 4 is a graphical illustration of HSQ thickness as a function of concentration based on the substrates with a siloxane primer and an ETC coating.

FIG. 5 is a graphical illustration of the static water contact angle of substrates with a siloxane primer and an ETC coating.

FIG. 6 is a chart depicting surface free energy vs. atmospheric pressure plasma for siloxane primers.

FIG. 7 is contour plot of cycles to failure for a substrate with siloxane primer at various thicknesses and plasma applications.

FIG. 8 is FTIR-ATR data of substrates with siloxane primer and ETC coating, cured at different temperatures and cured using atmospheric plasma at different speeds.

FIG. 9 is a plot of percent transmission vs. wavelength of light for substrates with siloxane primer and ETC coating.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

### Overview

Disclosed are an article and associated methods for making an easy-to-clean (“ETC”) coating (such as a fluoroether silane or perfluoroether silane coating having anti-fingerprint properties) having improved abrasion resistance. A multifunctional siloxane resin can be applied to a substrate to create a multilayered, crosslinked ETC coating on the surface of a glass substrate.

Discussed herein, a multilayered, crosslinked ETC coating can function such that, when one layer is abraded, ETC functional groups (such as silanes) are still available and bonded at the surface of the substrate on which the coating resides. This crosslinked ETC coating is useful for glass substrates having additional treatments such as anti-reflective (AR) or optical coatings that have a small number of reactive groups to bind with ETC-type coating functional groups such as silanes.

Silanes in ETC coatings have good reactivity with silanol groups located on glass surfaces. However, silane bonds to glass, as well as the perfluoroalkanes (or perfluoroethers) of ETC coatings, can degrade over time, due to factors such as UV exposure, hydrolytic degradation, or others. The glass substrate and associated ETC coating likewise can wear over time. Monolayer ETC coatings are generally thin, from about 2.5 nm to 10 nm in thickness, and are a monolayer. Thus, if the coating is degraded, whether by UV, thermooxidative, mechanical wear, hydrolysis, or other means, the ETC performance is substantially lost.

ETC coatings can be used on surfaces of substrates which are intended for use as touch displays, such as phones, tablets, or automotive displays. ETC films can impart hydrophobicity, oleophobicity and a more user friendly low friction “feel” to these surfaces. These surfaces can be glass or glass ceramics and can be surface modified for improved optical properties. Surface modifications can include adding antireflective films or other films or coatings for the touch display surfaces that can result in less durable ETC coatings when applied to those surfaces.

Durable ETC coatings can, for example, maintain high water contact angle (such as greater than 100 degrees) after mechanical abrasion. A high water contact angle can indicate the presence of such a coating. Native surfaces of substrates, such as glass and glass ceramics, can have lower water contact angles when clean, such as less than 10 degrees, due to their high surface free energy. A common test for coating durability for touch display substrates is a steel wool test, in which samples are abraded followed by water contact angle testing. Durable ETC coatings on touch displays are highly desirable as they prolong the useful life of a device with such a display.

Some substrate surfaces are not ideal for ETC bonding and ETC retention during abrasion. Non-ideal surfaces can have poor ETC abrasion resistance due to surface chemistry or roughness, can reflect substrate compositions, or can have surface modifications including washing, polishing, or application of other films or coatings such as anti-reflective films. Washing in aqueous media can etch or leach glass or glass ceramic surfaces. Polishing can contaminate surfaces with polishing residue. Additional films such as antireflective (“AR”) films deposited in a high vacuum can leave the surfaces rougher and hydroxyl-depleted which is not ideal for silane bonding.

ETC coatings are commonly composed of perfluoropolyether (PFPE) molecules which have been functionalized with a silane group to enable covalent bonding. An ETC coating of PFPE molecules can be applied to surfaces as thin films by multiple methods including: dip coating, spin coating, spray coating, chemical vapor deposition, or plasma vapor deposition.

Thicker ETC films are more durable compared with thinner films. ETC film thicknesses are self-limited when bound to polar surfaces as illustrated by the autophobic de-wetting of excess ETC. Autophobic de-wetting occurs when the surface energy of the top surface of a film is changed due to re-orientation of molecules. ETC thin films can be less than about 20 nm in thickness, depending on chain length and bonding density. Films thicker than a monolayer of ETC can be made by applying more unbound ETC, but additional ETC can result in decreased transmission due to haze.

ETC layers can be durable when a portion of available PFPE molecules are covalently bonded to the substrate, and a portion are unbonded and able to migrate via two dimensional diffusion to areas of lower concentration to maintain surface lubricity. Covalently bonded silane-PFPE leverages polar surface groups such as Si—OH (silanol) or hydroxyl to enable a multistep process of silane-silanol covalent bonding. PFPE bonding and durability can be affected by the density of hydroxyl groups on a substrate surface, therefor a surface which presents a uniform and tunable hydroxyl density can be advantageous.

Such an ETC coating can be applied on a glass or glass ceramic substrate for use as a touch display, such as a surface-modified substrate. The siloxane primer can be applied directly to the substrate as a thing film layer on all or part of the substrate surface, followed by application of the ETC coating. The two layers can be added directly to a glass or glass ceramic substrate, or over optical enhancement layers on the substrate, such as an antireflective (AR) or antiglare coating, without affecting optical performance.

The siloxane primer can be, for example, a polysiloxane primer film, such as a liquid polysiloxane T11 211 (Honeywell, Charlotte, N.C.), that increases ETC mechanical durability by specifically adapting the surface chemistry of the ETC. The durability of the ETC can, for example, be better when tested with standard abrasion techniques such as steel wool.

Discussed herein, an advantageous ETC coated substrate can include two layers: a polysiloxane primer film formed by the multifunctional siloxane resin, and an ETC film thereon, added to the substrate in that order. The primer layer can increase ETC mechanical durability as tested by linear abrasion with abradants such as steel wool. This can be accomplished by enabling tuning of surface chemistry (e.g., hydroxyl density) and increasing surface chemical uniformity which increase bonding of ETC.

Also described herein are methods for adjusting prescribed thickness of the siloxane primer film and curing of the siloxane primer film to allow durable ETC coatings on a variety of substrate types. Using atmospheric pressure (“AP”) plasma to cure the siloxane primer film can allow the siloxane primer film can be thin enough to avoid changing optical properties of the article, and enable a stable film. The siloxane primer film can be thick enough to present a continuous coating for uniformity of chemistry. Curing of the siloxane primer film with plasma allows tunable changes in surface chemistry to optimize bonding with the ETC layer. AP plasma can be tailored by altering the speed of application.

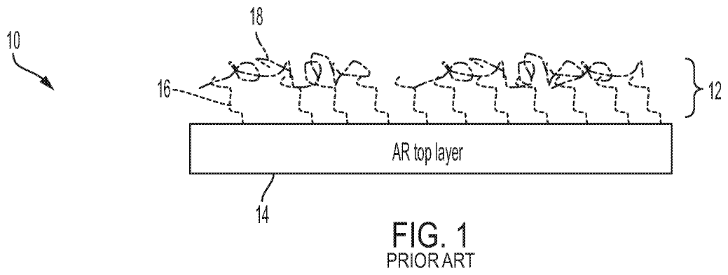

FIG. 1 is a schematic diagram of article 10 containing a prior art single-layer ETC 12 on an anti-reflective (AR) glass 14 without crosslinking. Here, AR glass 14 hosts ETC 12. ETC 12 contains bound ETC 16 and unbound ETC oligomers 18.

AR glass 14 is a glass substrate with an anti-reflective (AR) coating, on which ETC coating 12 resides. AR glass 14 can be, for example, a chemically strengthened glass for use in touch screen technologies.

ETC coating 12 on AR glass 14 is a prior art single layer ETC coating containing bound ETC 16 and unbound ETC oligomers 18. Here, bound ETC 16 create a single layer coating on AR glass 14 that is thin. Unbound ETC oligomers 18 are not networked with bound ETC 16. For this reason, the durability of ETC coating 12 on AR glass 14 is low, and ETC coating 12 can be abraded away. Other mechanical failures can occur in a single layer ETC.

This can be addressed by binding the ETC coating with a multifunctional siloxane resin, increasing effective ETC coating hardness. This use of a multifunctional siloxane resin increases the capacity of the ETC coating to create covalent bonds by providing additional reactive sites. This allows for ETC coating wear resistance; if the top-most layer of the ETC coating is damaged, the performance is retained by the resulting multilayer, crosslinked ETC coating.

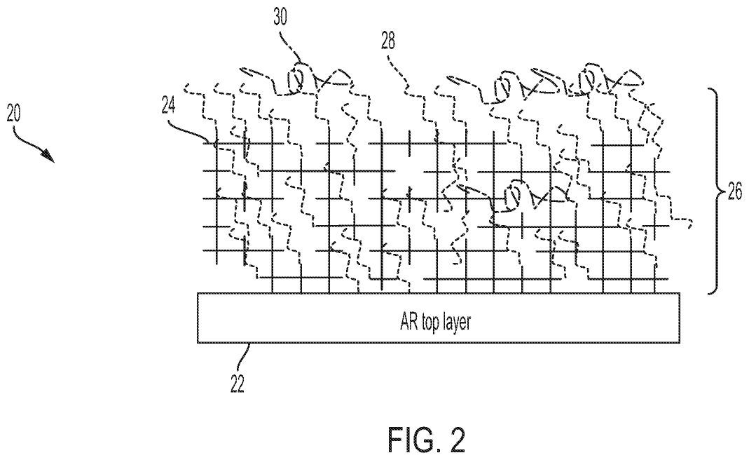

FIG. 2 is a schematic diagram of article 20 with a crosslinked ETC coating with a multifunctional siloxane resin on a substrate AR glass. Here, the AR glass 22 comprises multifunctional siloxane 24 and crosslinked ETC coating 26. Crosslinked ETC coating 26 contains bound ETC 28 and unbound ETC oligomers 30. On article 20, crosslinked ETC coating 26 is crosslinked by multifunctional siloxane resin 24. This allows for a more durable crosslinked ETC coating 26.

### The Substrate Glass

Glass substrates used in embodiments can be provided using a variety of different processes. For instance, where the glass substrate can be formed using known forming methods include float glass processes and down-draw processes such as fusion draw and slot draw. In some embodiments, the glass substrate can be formed from a “phase-separable” glass composition which can undergo phase separation into two or more distinct phases upon exposure to a phase separation treatment, such as a heat treatment or the like, to produce a “phase separated” glass including distinct glass phases having different compositions.

A glass substrate prepared by a float glass process can be characterized by smooth surfaces and uniform thickness is made by floating molten glass on a bed of molten metal, typically tin. In an example process, molten glass that is fed onto the surface of the molten tin bed forms a floating glass ribbon. As the glass ribbon flows along the tin bath, the temperature is gradually decreased until the glass ribbon solidifies into a solid glass substrate that can be lifted from the tin onto rollers. Once off the bath, the glass substrate can be cooled further and annealed to reduce internal stress.

Down-draw processes produce glass substrates having a uniform thickness that possess relatively pristine surfaces. Because the average flexural strength of glass substrates is controlled by the amount and size of surface flaws, a pristine surface that has had minimal contact has a higher initial strength. When this high strength glass substrate is then further strengthened (e.g., chemically or thermally), the resultant strength can be higher than that of a glass substrate with a surface that has been lapped and polished. Down-drawn glass substrates can be drawn to a thickness of less than about 2 mm. In addition, down drawn glass substrates have a very flat, smooth surface that can be used in its final application without additional grinding and polishing steps.

The glass substrate can be formed using a fusion draw process, for example, which uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass substrate. The fusion draw method offers the advantage that, because the two glass films flowing over the channel fuse together, neither of the outside surfaces of the resulting glass substrate comes in contact with any part of the apparatus. Thus, the surface properties of the fusion drawn glass substrate are not affected by such contact.

The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous material and into an annealing region.

In some embodiments, the compositions used for the glass substrate making up the glass substrate can be batched with about 0 mol % to about 2 mol. % of at least one fining agent selected from a group that includes Na₂SO₄, NaCl, NaF, NaBr, K₂SO₄, KCl, KF, KBr, and SnO₂.

Once formed, the glass substrate can be strengthened to form a strengthened glass substrate. It should be noted that glass-ceramics described herein can also be strengthened in the same manner as glass substrates. As used herein, the term “strengthened material” generally refers to a glass substrate or a glass-ceramic material that has been chemically strengthened, for example through ion-exchange of larger ions for smaller ions in the surface of the glass or glass-ceramic material. However, other strengthening methods known in the art, such as thermal tempering, can be utilized to form strengthened glass substrates and/or glass-ceramic materials. In some embodiments, the materials can be strengthened using a combination of chemical strengthening processes and thermally strengthening processes.

The strengthened materials described herein can be chemically strengthened by an ion exchange process. In the ion-exchange process, typically by immersion of a glass or glass-ceramic material into a molten salt bath for a predetermined period of time, ions at or near the surface(s) of the glass or glass-ceramic material are exchanged for larger metal ions from the salt bath. In one embodiment, the temperature of the molten salt bath is in the range from about 400° C. to about 430° C. and the predetermined time period is about four to about twenty-four hours; however, the temperature and duration of immersion can vary according to the composition of the material and the desired strength attributes. The incorporation of the larger ions into the glass or glass-ceramic material strengthens the material by creating a compressive stress in a near surface region or in regions at and adjacent to the surface(s) of the material. A corresponding tensile stress is induced within a central region or regions at a distance from the surface(s) of the material to balance the compressive stress. Glass or glass-ceramic materials utilizing this strengthening process can be described more specifically as chemically-strengthened or ion-exchanged glass or glass-ceramic materials.

In one example, sodium ions in a strengthened glass or glass-ceramic material are replaced by potassium ions from the molten bath, such as a potassium nitrate salt bath, though other alkali metal ions having larger atomic radii, such as rubidium or cesium, can replace smaller alkali metal ions in the glass. According to particular embodiments, smaller alkali metal ions in the glass or glass-ceramic can be replaced by Ag+ ions. Similarly, other alkali metal salts such as, but not limited to, sulfates, phosphates, halides, and the like can be used in the ion exchange process.

The replacement of smaller ions by larger ions at a temperature below that at which the glass network can relax produces a distribution of ions across the surface(s) of the strengthened material that results in a stress profile. The larger volume of the incoming ion produces a compressive stress (CS) on the surface and tension (central tension, or CT) in the center of the strengthened material. The compressive stress is related to the central tension by the following relationship:

$$CS = CT ( \frac{1 - 2 DOL}{DOL} )$$

where it is the total thickness of the strengthened glass or glass-ceramic material and compressive depth of layer (DOL) is the depth of exchange. Depth of exchange can be described as the depth within the strengthened glass or glass-ceramic material (i.e., the distance from a surface of the glass substrate to a central region of the glass or glass-ceramic material), at which ion exchange facilitated by the ion exchange process takes place.

In one embodiment, a strengthened glass or glass-ceramic material can have a surface compressive stress of about 300 MPa or greater, e.g., 400 MPa or greater, 450 MPa or greater, 500 MPa or greater, 550 MPa or greater, 600 MPa or greater, 650 MPa or greater, 700 MPa or greater, 750 MPa or greater or 800 MPa or greater. The strengthened glass or glass-ceramic material can have a compressive depth of layer about 15 μm or greater, 20 μm or greater (e.g., 25 μm, 30 μm, 35 μm, 40 μm, 45 μm, 50 μm or greater) and/or a central tension of about 10 MPa or greater, 20 MPa or greater, 30 MPa or greater, 40 MPa or greater (e.g., 42 MPa, 45 MPa, or 50 MPa or greater) but less than 100 MPa (e.g., 95, 90, 85, 80, 75, 70, 65, 60, 55 MPa or less). In one or more specific embodiments, the strengthened glass or glass-ceramic material has one or more of the following: a surface compressive stress greater than about 200 MPa, a depth of compressive layer greater than about 15 μm, and a central tension greater than about 18 MPa. In one or more embodiments, the \one or both the first substrate and the second substrate is strengthened, as described herein. In some instances, both the first substrate and the second substrate are strengthened. The first substrate can be chemically strengthened, while the second substrate is thermally strengthened. In some instances, only one of the first substrate and the second substrate are chemically and/or thermally strengthened, while the other is not strengthened.

Any number of glass compositions can be employed in the glass substrate and include alkali aluminosilicate glass compositions or alkali aluminoborosilicate glass compositions, though other glass compositions are contemplated. Such glass compositions can be characterized as ion exchangeable. As used herein, “ion exchangeable” means that a material comprising the composition is capable of exchanging cations located at or near the surface of the material with cations of the same valence that are either larger or smaller in size.

For example, a suitable glass composition comprises SiO₂, B₂O₃ and Na₂O, where (SiO₂+B₂O₃)≥66 mol. %, and Na₂O≥9 mol. %. In an embodiment, the glass sheets include at least 6 wt. % aluminum oxide. In a further embodiment, a glass sheet includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio:

(Al2O₃+B₂O₃)/Σmodifiers>1

where in the ratio the components are expressed in mol. % and the modifiers are alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio:

(Al₂O₃+B₂O₃)/Σmodifiers>1

In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol. %≤Li₂O+Na₂O+K₂O≤20 mol. % and 0 mol. %≤MgO+CaO≤10 mol. %.

In still another embodiment, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)≤Al₂O₃≤2 mol. %; 2 mol. %≤Na₂O≤Al₂O₃≤6 mol. %; and 4 mol. %≤(Na₂O+K₂O)≤Al₂O₃≤10 mol. %. Additional examples for generating ion exchangeable glass structures are described in Published U.S. Appl. No. US 2014-0087193 A1 and U.S. Pat. No. 9,387,651 the entirety of each being incorporated herein by reference.

In an alternative embodiment, the glass substrate comprises an alkali aluminosilicate glass composition comprising: 2 mol % or more of Al₂O₃ and/or ZrO₂, or 4 mol % or more of Al₂O₃ and/or ZrO₂.

In some embodiments, the glass substrate comprises a glass-ceramic material that can be fusion-formed or formed by other known methods such as rolling, thin-rolling, slot draw or float.

Glass-ceramics that can be used in various embodiments can be characterized by the processes by which they can be formed. Such glass-ceramics can be formed by float processes, fusion processes, slot draw process, thin rolling processes, or a combination thereof. Some glass-ceramics tend to have liquid viscosities that preclude the use of high throughput forming methods such as float, slot draw, or fusion draw. For example, some known glass-ceramics are formed from precursor glasses having liquidus viscosities of about 10 kP, which are not suitable for fusion draw, where liquidus viscosities of above about 100 kP or above about 200 kP are generally required. Glass-ceramics formed by the low throughput forming methods (e.g., thin rolling) can exhibit enhanced opacity, various degrees of translucency, and/or surface luster. Glass-ceramics formed by high throughout methods (e.g., float, slot draw, or fusion draw) can achieve very thin layers. Glass-ceramics formed by fusion draw methods can achieve pristine surfaces and thinness (e.g., about 2 mm or less). Examples of suitable glass-ceramics can include Li₂O—Al₂O₃—SiO₂ system (i.e. LAS-System) glass-ceramics, MgO—Al₂O₃—SiO₂ system (i.e. MAS-System) glass-ceramics, glass-ceramics including crystalline phases of any one or more of mullite, spinel, α-quartz, β-quartz solid solution, petalite, lithium disilicate, β-spodumene, nepheline, and alumina, and combinations thereof.

In one or more embodiments, one or both the first and second substrate (12/16) comprise a thickness of about 3 mm or less. In some instances, one of the first and the second substrate has a thickness of about 1 mm to about 3 mm (e.g., from about 1 mm to about 2.8 mm, from about 1 mm to about 2.6 mm, from about 1 mm to about 2.5 mm, from about 1 mm to about 2.4 mm, from about 1 mm to about 2.1 mm, from about 1 mm to about 2 mm, from about 1 mm to about 1.8 mm, from about 1 mm to about 1.6 mm, from about 1 mm to about 1.4 mm, from about 1.2 mm to about 3 mm, from about 1.4 mm to about 3 mm, from about 1.6 mm to about 3 mm, or from about 1.8 mm to about 3 mm), and the other of the first and the second substrate has a thickness of less than 1 mm (e.g., about 0.9 mm or less, about 0.8 mm or less, about 0.7 mm or less, about 0.5 mm or less, about 0.55 mm or less, about 0.4 mm or less, about 0.3 mm or less, or about 0.2 mm or less). The combination of thicknesses for the first substrate and the second substrate can include but are not limited to 2.1 mm/0.7 mm, 2.1 mm/0.5 mm, 1.8 mm/0.7 mm, 1.8 mm/0.5 mm, 1.6 mm/0.5 mm, 1 mm/0.7 mm, and 1 mm/0.5 mm.

The glass substrates of the disclosure generally have a stiffness of at least above 90 N/mm, above about 95 N/mm, above about 99 N/mm; from about 90 N/mm to about 100 N/mm, about 95 N/mm to about 100 N/mm, or about 97 N/mm to about 100 N/mm as determined using a ball on ring method for determining stiffness at a rate of deformation of 0.0017 mm/sec.

In one or more embodiments, the glass substrate can have a complexly curved shape. As used herein, “complex curve”, “complexly curved”, “complex curved substrate” and “complexly curved substrate” mean a non-planar shape having compound curves, also referred to as non-developable shapes, which include but are not limited to a spherical surface, an aspherical surface, and a toroidal surface, where the curvature of two orthogonal axes (horizontal and vertical one) are different, which can be for example a toroidal shape, an oblate spheroid, oblate ellipsoid, prolate spheroid, prolate ellipsoid, or where the surface's principle curvature along two orthogonal planes are opposite, for example a saddle shape or surface, such as a horse or monkey saddle. Other examples of a complex curves include, but are not limited to, an elliptic hyperboloid, a hyperbolic paraboloid, and a spherocylindrical surface, where the complex curves can have constant or varying radii of curvature. The complex curve can also include segments or portions of such surfaces or be comprised of a combination of such curves and surfaces. In one or more embodiments, a glass substrate can have a compound curve including a major radius and a cross curvature. The curvature of the glass substrate can be even more complex when a significant minimum radius is combined with a significant cross curvature, and/or depth of bend. Some glass substrates can also require bending along axes of bending that are not perpendicular to the longitudinal axis of the flat glass substrate.

In one or more embodiment, the glass substrate can have radii of curvature along two orthogonal axes. In various embodiments, the glass substrate can be asymmetrical. Some glass substrates can also include bending along axes that are not perpendicular to the longitudinal axis of the substrates, prior to forming (i.e., a flat surface or flat substrate).

In one or more embodiment, the radii of curvature can be less than 1000 mm, or less than 750 mm, or less than 500 mm, or less than 300 mm. In various embodiments, the glass substrate is substantially free of wrinkles or optical distortions, including at the edges of the glass substrate.

In one or more embodiments, the glass substrate can be characterized as a cold-formed glass substrate. In such embodiments, the glass substrate includes first curved substrate and a substantially planar second substrate, wherein the second substrate is cold formed to the curvature of the first substrate.

As used herein, cold form includes a forming process in which the substrates and/or the glass substrate is formed at a temperature less than the softening temperature of the first and second substrates to provide a complexly curved glass substrate.

Embodiments of the cold formed glass substrate can include at least one interlayer and at least one light responsive material, as both described herein, disposed between the first and second substrate. The cold formed glass substrate can include a display unit as described herein. In one or more embodiments, the second substrate is strengthened by forming to the curvature of the first substrate. The cold-formed glass substrate can be complexly curved as described herein.

Laminates comprising a combination of one or more layers of the glass substrates described herein are also contemplated herein. Chemically-strengthened glass substrates, such as AR glass 22, include glass substrates which have been treated by an ion exchange strengthening process. Chemically-strengthened glass substrates typically have a coefficient of thermal expansion (CTE) ranging between about 80×10⁻⁷/° C. to about 100×10⁻⁷/° C. The glass substrate can be an aluminosilicate glass, a borosilicate glass, an aluminoborosilicate glass, or alkali-containing forms thereof. One suitable commercial embodiment of the glass substrate is Gorilla® glass produced by Corning Inc. Exemplary Gorilla glass compositions are provided in US Publication No. 20110045961, which is incorporated by reference herein in its entirety. Chemically-strengthened glass can have an identifiable compressive stress layer extending through at a least a portion of the glass substrate. The compressive stress layer can have a depth of greater than 30 μm. Chemically-strengthened glass can a flexural strength value defined by ring on ring testing (ROR)>300 MPa. Chemically-strengthened glass can have a thickness between about 0.5 mm to about 5 mm, between about 1 to about 3 mm, less than 3 mm, less than 2 mm, from about 0.3 mm to about 4.0 mm, from about 0.5 to about 2 mm, or from about 0.7 mm to about 1.5 mm. The chemically-strengthened glass substrates need not be limited to any specific ion exchange process. For the sake of illustration, an example ion exchange strengthening process can be conducted at a temperature of about 390° C. to about 500° C., or about 410° C. to about 450° C. for about 5 to about 15 hours.

### The Multifunctional Siloxane Resin

The multifunctional siloxane resin 24 is a resin that can react with (1) itself to form resin-resin bonds, (2) silane groups such as those found in ETC coatings, and (3) surface silanol groups found on glass (or other SiOx or other metal oxide containing surfaces). Thus, multifunctional siloxane resin 24 serves to network the silane groups of the ETC coating 26 to the silanol groups on the surface of AR glass 22, creating a multi-layer network ETC coating 26 including bound ETC 28. Unbound ETC oligomers 30 reside in and around the networked ETC.

Multifunctional siloxane resin 24 can be, for example, an organosiloxane resin comprising at least 60 mole % of [R²SiO_{3/2}] siloxy units in its formula, where each R² is independently a C₁ to C₂₀ hydrocarbyl. The organosiloxane resin can contain any amount and combination of other M, D, and Q siloxy units, provided the organosiloxane resin contains at least 70 mole % of [R²SiO_{3/2}] siloxy units, alternatively the organosiloxane resin contains at least 80 mole % of [R²SiO_{3/2}] siloxy units, alternatively the organosiloxane resin contains at least 90 mole % of [R²SiO_{3/2}] siloxy units, or alternatively the organosiloxane resin contains at least 95 mole % of [R²SiO_{3/2}] siloxy units. In some embodiments, the organosiloxane resin contains from about 70 to about 100 mole % of [R²SiO_{3/2}] siloxy units, e.g., from about 70 to about 95 mole % of [R²SiO_{3/2}] siloxy units, from about 80 to about 95 mole % of [R²SiO_{3/2}] siloxy units or from about 90 to about 95 mole % of [R²SiO_{3/2}] siloxy units. Organosiloxane resins useful as multifunctional siloxane resin include those known as “silsesquioxane” resins.

Each R² can independently be a C₁ to C₂₀ hydrocarbyl. R² can be an aryl group, such as phenyl, naphthyl, anthryl group. Alternatively, R² can be an alkyl group, such as methyl, ethyl, propyl, or butyl. Alternatively, R² can be any combination of the aforementioned alkyl or aryl groups. Alternatively, R² is phenyl or methyl.

The weight average molecular weight (M_{w}) of the organosiloxane resin is not limiting, but, in some embodiments, ranges from 1000 to 10,000, or alternatively 1500 to 5000 g/mole.

One skilled in the art recognizes that organosiloxane resins containing such high amounts of [R²SiO_{3/2}] siloxy units will inherently have a certain concentration of Si—OZ, where Z can be hydrogen (i.e., silanol), an alkyl group (so that OZ is an alkoxy group). Alternatively, OZ can also be a hydrolyzable groups such as hydrogen, an alkyl group, an oximo group, an epoxy group, a carboxy group, an amino group, an amido group, or combinations thereof. The concentration of the OZ groups present on the organosiloxane resin will vary, as dependent on the mode of preparation, and subsequent treatment of the resin. In some embodiments, the silanol (Si—OH) content of organosiloxane resins suitable for use in the present process will have a silanol content of at least 5 mole %, alternatively of at least 10 mole %, alternatively 25 mole %, alternatively 40 mole %, or alternatively 50 mole %. In other embodiments, the silanol content is from about 5 mole % to about 60 mole %, e.g., from about 10 mole % to about 60 mole %, from about 25 mole % to about 60 mole %, from about 40 mole % to about 60 mole %, from about 25 mole % to about 40 mole % or from about 25 mole % to about 50 mole %.

The multifunctional siloxane resin 24 can be a suitable resin having silanol or hydroxyl functionalities such that the resin 26 serves as a cross-linker between ETC coating 26 and substrate 24. Alternatively, the multifunctional resin 24 can contain other functionalities that react with hydroxide, such as via ester formation, ether via epoxide ring opening, or other appropriate functionalities. Other silane or alcohol reactive multifunctional crosslinkers can be used, such as, for example, multifunctional epoxy, appended onto with alkyl diamine (e.g., bis functional) or with higher multiples of nucleophiles (e.g., amine or others) whether reinforced with particles (e.g., silica, alumina, etc.) or fibers (e.g., glass, cellulose, etc.).

As a cross linker or intermediary between the substrate glass and the easy to clean coating (a functionalized fluorine containing compound, e.g., a fluoropolymer), the multifunctional siloxane resin can also include multiply branched, difunctional or more preferably, T-resins or Q-resins type (i.e., tri or tetra functional) siloxanes and preceramic polymers such as polysilaxanes, or thermally or UV labile polysilsesquioxanes. For example, thermally labile poly(2-acetoxyethylsilsesquioxane) for thermal or UV labile poly(2-Bromoethylsilsesquioxane)

Alternatively, a precursor, such as the HSQ precursor trimethoxysilane, can be used for the multifunctional siloxane resin, to form an oligomeric Si—O—Si network without gelation. A pre-oligomerized version could be used to sol-gel precursors such as TEOS (tetraethyl orthosilicate), TMOS (tetramethyl orthosilicate), alkyl functionalized such as alkyltrialkoxysilanes, due to the higher shrinkage of the resulting network and lowered film mechanical strength due to the higher porosity and film strain.

In other embodiments, the multifunctional resin can be an epoxy resin functionalized to create ether-type bonds, other nucleophilic substitutions, or ester formation. Alternatively, the multifunctional resin could, for example, have silanol condensation functionalities, or be an activated carboxylate for ester formation.

### The Functionalized Fluorine Containing Compounds

Functionalized fluorine containing compounds contemplated herein include, but are not limited to, fluoropolymer compounds of the general formula I:

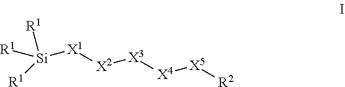

wherein:
each R¹ is, independently, alkyl, chloro, alkoxy, hydroxyl, acetoxy, bromo or other leaving groups with the proviso that at least two of R¹ are chloro, alkoxy or hydroxy;

### R² is H or F;

X¹-X⁵ are each, independently, selected from the group:
(CH₂)ₐ, wherein a has a value of from 0 to 20;
(CF₂)_{b}, wherein b has a value of from 0 to 20;
(OCH₂)_{c1}—(OC₂H₄)_{c2}—(OC₃H₆)_{c3}—(OC₄H₈)_{c4}, wherein c1, c2, c3, and c4 is each, independently, from 0 to 20;
(OCF₂)_{d1}—(OC₂F₄)_{d2}—(OC₃F₆)_{d3}—(OC₄F₈)_{d4}, wherein d1, d2, d3, and d4 is each, independently, from 0 to 20;

Examples of compounds of the formula I include trifluoro methyl trimethoxy silane, trifluoromethyl triethoxy silane, trifluoropropy trimethoxy silane, trifluoropropyl triethoxy silane, nonafluorobutylethyl trimethoxy silane, nonafluorohexyl trimethoxy silane, nonafluorohexyl trimethylethoxy silane, heptadecafluorodecyl trimethoxy silane, heptadecafluorodecyltrimethyl ethoxy silane, and the like.

In some embodiments, the functionalized fluorine containing compound can include cyclic versions of fluoropolymers, such as Cytop®, amorphous fluoroplastics such as Teflon® AF, or other types of functionalized fluoropolymers.

### Crosslinkers

In some embodiments, crosslinkers can be used to promote resin-resin compounding or coupling between the functionalized fluorine containing compounds already bound to the resin. Crosslinkers can include an organosilane having the formula

R³_{q}SiX_{4-q},

where R³ is a C₁ to C₈ hydrocarbyl or a C₁ to C₈ halogen-substituted hydrocarbyl; X is a hydrolyzable group; and q is 0, 1, or 2. R³ can be a C₁ to C₈ hydrocarbyl or a C₁ to C₈ halogen-substituted hydrocarbyl, or alternatively R³ can be a C₁ to C₈ alkyl group, or alternatively a phenyl group, or alternatively R³ can be methyl, ethyl, or a combination of methyl and ethyl. X is any hydrolyzable group, E or, alternatively, X can be an oximo, acetoxy, halogen atom, hydroxyl (OH), or an alkoxy group.

In one embodiment, the organosilane having the formula R³_{q}SiX_{4-q} is an alkyltriacetoxysilane, such as methyltriacetoxysilane, ethyltriacetoxysilane, or a combination of both. Commercially available representative alkyltriacetoxysilanes include ETS-900 (Dow Corning Corp., Midland, Mich.).

Other suitable, non-limiting organosilanes useful, e.g., as crosslinkers include; methyl-tris(methylethylketoxime)silane (MTO), methyl triacetoxysilane, ethyl triacetoxysilane, tetraacetoxysilane, tetraoximesilane, dimethyl diacetoxysilane, dimethyl dioximesilane, and methyl tris(methylmethylketoxime)silane.

### The Easy-to-Clean Coating

The crosslinked ETC coating 26 can be, for example, a functionalized fluorine containing compound (as described above), such as a fluoroether silane or a perfluoroether silane optionally having crosslinkers (as described above). In some embodiments, the crosslinked ETC coating 26 can be an amorphous fluorine containing compound incorporating ring structures.

Silanes in ETC coatings such as the crosslinked ETC coating 26 interact with reactive groups available at the surface of a substrate such as AR glass 22. ETC coatings are sensitive to surface activation methods such as piranha treatment, plasma, wash, or other appropriate methods. Glass surfaces or other oxide surfaces, such as anti-reflective coated surfaces like AR glass 22, without many reactive groups tether to a smaller number of silanes found in ETC coatings.

The crosslinked ETC coating 26 has one or more functional groups that crosslink with the multifunctional siloxane resin 24. These functional groups are represented schematically in FIG. 2 by bound ETC 28 and ETC oligomers 30. The thickness of the ETC coating is determined by the amount of material coated, rather than the number of surface reactive groups. There can be unbound excess material (ETC oligomers 30), but unbound material ETC oligomers 30 will not last if it is not chemically bound to the surface it is meant to protect.

The addition of a multifunctional siloxane resin 24, such as hydrogen silsesquioxane (HSQ), acts as a crosslinker to tether to the substrate, but also to incorporate, by chemical bonding, more fluoroether silanes (bound ETC 28 and ETC oligomers 30) into the coating. Rather than one monolayer of the fluoroether silane coating, this type of appended onto coating enables multilayered structures so that when one layer is abraded away, fluoroether groups are still available and functioning at the surface. The crosslinked ETC coating 26 has a thickness of from about 15 nm and about 100 nm.

The crosslinked ETC coating 26 incorporating the multifunctional siloxane resin 24 is abrasion resistant and can have a water contact angle of above 100. In particular, the coating can have a water contact angle in a range of about 90 degrees to about 130 degrees after 200,000 cycles cheesecloth testing. Alternatively, the coating can have a water contact angle in a range of about 90 degrees to about 120 degrees after 3000 cycles steel wool testing.

The ETC coating can have a porosity of about 0.10% to about 30.00%, or preferably porosity of about 0.10% to about 15.00%. Overall, the multifunctional siloxane resin can be about 0.01 wt. % to about 25 wt. % of the ETC coating (e.g., about 0.025 wt. % and 0.25 wt. % of the coating). In some embodiments, an additive can be additionally included in the crosslinked ETC coating 26, such as a light stabilizer or colorant.

### Methodology

In various embodiments, the crosslinked ETC coating can be made by applying the multifunctional siloxane resin to the substrate AR glass, applying a functionalized fluorine containing compound to the substrate (the ETC component), and annealing the multifunctional siloxane resin and the functionalized fluorine containing compound to induce crosslinking and hardening of the ETC coating. Annealing the coating can be done at a temperature of about 300 degrees Celsius to about 500 degrees Celsius (e.g., about 350 degrees Celsius to about 450 degrees Celsius).

Applying the multifunctional siloxane resin to the substrate can be done by spin coating a thin layer of the resin onto the AR glass substrate, by solution processes, such as spray coating, dip coating, spin coating, contact printing, or chemical vapor deposition, or evaporation of the multifunctional siloxane resin. The multifunctional siloxane resin can be dissolved in a solvent such as, for example, methyl isobutyl ketone (MIBK), ethanol, or other appropriate solvent (e.g., HFE7200 from 3M®).

The functionalized fluorine containing compound to the substrate can be done subsequently to or simultaneously with application of the multifunctional siloxane resin. If applied subsequently, the functionalized fluorine containing compound can be spray coated onto the AR glass substrate. The functionalized fluorine containing compound can be dissolved in a solvent such as, for example, fluorinated solvents such as trifluoroethanol, toluene, or other solvents known in the art (e.g., HFE7200 from 3M®). If the multifunctional siloxane resin and the functionalized fluorine containing compound are applied simultaneously, the multifunctional siloxane resin and the functionalized fluorine containing compound can be mixed together in solution prior to application. In this case, the solvent used can be, for example, fluoroether type solvents, MIBK, trifluoroethanol, or other solvents as appropriate in the art. (e.g., HFE7200 from 3M®).

The resulting coating can then be dried, and, optionally, cured with heat by subjecting to high temperatures or cured by other applied energy such as e-beam or plasma, whether oxygen or air, vacuum, or atmospheric. The cure can optionally be accelerated by the addition of a base catalyst.

In various embodiments, the process can include preparing the substrate surface, such as with a plasma, followed by modifying a substrate surface with a polysiloxane liquid, curing of that polysiloxane liquid to form a polysiloxane layer, application of an ETC coating to the polysiloxane layer, curing of the ETC coating, and removal of excess ETC.

The glass or ceramic substrate can be cleaned using a detergent wash in an ultrasonic bath. The detergent can include detergents with less than about 12 pH, in some cases ultrasonics can also be used. The substrate can be rinsed and dried, using a method that would not add molecular organic contamination to the surface of substrate. Examples drying methods include blowing with clean dry air or nitrogen gas. Next, an oxygen plasma can be added to the substrate for further cleaning at about three minutes in vacuum.

A liquid polysiloxane film can then applied to the cleaned surface of the substrate The material for the siloxane primer film can be, for example, a liquid polysiloxane dissolved in a solvent which can be deposited onto a substrate to form a thin film in the form of a silicone or polysiloxane. As discussed above, this material can include a siloxane backbone with methyl or other side groups which can be converted to hydroxyl groups with oxygen plasma. This can include, but is not limited to, polymethylsiloxane, polyhydroxylmethylsiloxane, and polydimethylsiloxane.

The thickness of the polysiloxane film can be adjusted through modification using the liquid polysiloxane spinning, spray coating, dip coating, or directly through plasma application. The thickness of the film can be controlled to optimize effectiveness by dilution of silicone in an appropriate solvent. The thickness can be manipulated by changing spin speed and duration for spin coating. Alternatively, ultrasonic spray can be used as a method of application.

The siloxane primer film can be applied and/or cured using atmospheric pressure (“AP”) plasma. AP plasma has the advantage of compatibility with in-line processing. Parts can be moved below a plasma source or the source moved relative to parts. Plasma dose is related to duration of exposure with slow speeds equating to higher doses. Gases used to form plasmas vary, but usually an inert gas such as helium or argon can be combined with an active gas such as oxygen (when trying to oxidize) or hydrogen (when trying to reduce). Dose can also be controlled with distance from surface, power (Watts) and gas flow rates.

The substrate with the applied polysiloxane can be cured, such as by exposure to atmospheric pressure plasma (“AP plasma”). Dosage can be adjusted depending on the specific chemistry of the polysiloxane liquid used.

After curing of the polysiloxane, the ETC coating can be applied. The ETC can be a silane-PFPE composition. This was can be applied by dipping. A fast manual withdrawal speed can be used to enable thicker films, due to autophobic de-wetting. Other ETC coating can be used. The ETC coating could alternatively be applied by spray, chemical vapor deposition, or other techniques.

Next, the ETC coating can be cured. The coated substrate can be placed in an oven, cured with steam or superheated steam, or the coating can be left at room temperature for a longer period of time. Finally, excess ETC can be removed, such as by ultrasonic rinse in water or a solvent. Alternatively, excess ETC can be removed by wiping. All droplets of excess ETC can be removed and checked using laser confocal or optical microscopy. Removal allows reduction of haze and for checking of abrasion data unbiased by excess ETC.

The glass substrate with crosslinked ETC coating can be used in a variety of commercial applications, including but not limited to automotive displays, for interior displays and other surfaces, in addition to consumer electronic devices such as phones, tablets, or watches.

### Definitions

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading can occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “aryl” as used herein refers to cyclic aromatic hydrocarbon groups that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “resin” as used herein refers to polysiloxane material of any viscosity including a molecule that includes at least one siloxane monomer that is bonded via a Si—O—Si bond to three or four other siloxane monomers. In one example, the polysiloxane material includes T or Q units, as defined herein.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mᵢ through the formula Mₙ=ΣMᵢnᵢ/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The term “cure” as used herein refers to exposing to radiation in any form, heating, or allowing to undergo a physical or chemical reaction that results in hardening or an increase in viscosity.

The term “solvent” as used herein refers to a liquid that can dissolve a solid, liquid, or gas. Non-limiting examples of solvents are silicones, organic compounds, water, alcohols, ionic liquids, and supercritical fluids.

The term “silicate” as used herein refers to any silicon-containing compound wherein the silicon atom has four bonds to oxygen, wherein at least one of the oxygen atoms bound to the silicon atom is ionic, such as any salt of a silicic acid. The counterion to the oxygen ion can be any other suitable ion or ions. An oxygen atom can be substituted with other silicon atoms, allowing for a polymer structure. One or more oxygen atoms can be double-bonded to the silicon atom; therefore, a silicate molecule can include a silicon atom with 2, 3, or 4 oxygen atoms. Examples of silicates include aluminum silicate. Zeolites are one example of materials that can include aluminum silicate. A silicate can be in the form of a salt or ion.

The term “room temperature” as used herein refers to a temperature of about 15° C. to 28° C.

The term “standard temperature and pressure” as used herein refers to 20° C. and 101 kPa.

The term “coating” as used herein refers to a continuous or discontinuous layer of material on the coated surface, wherein the layer of material can penetrate the surface and can fill areas such as pores, wherein the layer of material can have any three-dimensional shape, including a flat or curved plane. In one example, a coating can be formed on one or more surfaces, any of which can be porous or nonporous, by immersion in a bath of coating material.

The term “surface” as used herein refers to a boundary or side of an object, wherein the boundary or side can have any perimeter shape and can have any three-dimensional shape, including flat, curved, or angular, wherein the boundary or side can be continuous or discontinuous. While the term surface generally refers to the outermost boundary of an object with no implied depth, when the term ‘pores’ is used in reference to a surface, it refers to both the surface opening and the depth to which the pores extend beneath the surface into the substrate.

Herein, when it is designated that a variable in the structure can be “a bond,” the variable can represent a direct bond between the two groups shown as linked to that variable, such as a single bond.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

### EXAMPLES

Various embodiments of the present disclosure can be better understood by reference to the following Examples which are offered by way of illustration. The present disclosure is not limited to the Examples given herein.

### Example 1: Hydrogen Silsesquioxane (HSQ) Formulation on Glass

In Example 1, samples 1-5, easy-to-clean coatings (ETC) (UD 509 available from Daikin America LLC, Orangeburg, N.Y.) with and without a multifunctional siloxane resin, hydrogen silsesquioxane (HSQ) (FOx-25, available from Dow Chemicals, Midland, Mich.), were applied to chemically strengthened glass substrates (Gorilla Glass® from Corning Inc., Corning, N.Y.) and cured for 30 minutes at 150° C. The coatings were applied by spin coating, diluted with ethoxy-nonafluorobutane (available from 3M®, St. Paul, Minn. (HFE7200)) on plasma cleaned glass (air plasma), and cured in an ambient atmosphere oven. The coating was also applied both in one step (as an integrated coating) or two steps, with HSQ as an intermediary.

The abrasion resistance was tested by use of a Linear Taber Abrader (Model 5750, available from Taber Industries, North Tonawanda, N.Y.), using a cylindrical tip with a radius of 2 cm, affixed with 4 layers of cheesecloth wrap (Crockmeter Squares for American Standards, 200877, available from SDL Atlas USA, Rock Hill, S.C.) and with a constant load of 750 g. The pathlength of each swipe was 15 mm, with each cycle consisting of a forward and backward swipe and returning the tip to its original position before proceeding with the next cycle. The speed was 30 cycles per minute, testing under ambient temperature (23° C.). The results are shown in Table 1 below:

TABLE 1
Samples 1-5

| | | | ETC | approx. | Water Contact Angle | | |
|---|---|---|---|---|---|---|---|
| | | | (UD | HSQ:ETC | as | 200 k | 400 k |
| | | HSQ | 509) | ratio | made | cycles | cycles |
| Sample 1 | Control | 0.00% | 0.12% | N/A | 111.2 | | 39.8 |
| | (ETC) | | | | | | |
| Sample 2 | HSQ 1 | 10.00% | 0.06% | 200:1 | 109.7 | 92.2 | |
| Sample 3 | HSQ 2 | 2.00% | 0.11% | 20:1 | 108.7 | 112 | |
| Sample 4 | HSQ 3 | 0.20% | 0.12% | 2:1 | 109.5 | 114.9 | 116.4 |
| Sample 5 | step 1 | 10% | 0 | | | | |
| (2 Steps) | step 2 | 0 | 0.12% | N/A | 90.5 | 67.5 | |

Samples 1-5 showed the potential amount of HSQ that might be needed to strengthen ETC coatings, although this could be adjusted to suit the properties needed in the ETC coating such as hardness.

The addition of a 2:1 ratio by mass of HSQ to ETC in Sample 3 appeared to have some beneficial durability as the coating of Sample 3 retained its hydrophobic property after 400 k cycles (or 800 k wipes) of cheese cloth abrasion testing even when the control sample, Sample 1, did not.

The addition of HSQ to Samples 2-5 did not degrade performance of the coating as made. Sample 5, the two-step process, was less successful, as the resulting HSQ surface was not more reactive than the glass substrate itself and in fact, appeared to be less reactive without modifications.

### Example 2: HSQ Formulation on Anti-Reflective (AR) Coated Glass

The durability of ETC on glass is superior to ETC coated on anti-reflective (AR) with a SiO₂ coated top layer. Samples 6-8 show the effect of HSQ (FOx-25, available from Dow Chemicals, Midland, Mich.) in an ETC on AR (MFA2 AR3.0) coated glass (Gorilla Glass® from Corning Inc., Corning, N.Y.).

TABLE 2
Samples 6-8

| | | | | | Water Contact | |
|---|---|---|---|---|---|---|
| | | | | Approx. | Angle | |
| | | | | HSQ:ETC | | 200 k |
| | | HSQ | ETC | ratio | as made | cycles |
| Sample 6 | Control | 0.00% | 0.12% | N/A | 114.1 | 81.7 |
| | AR (ETC) | | | | | |
| Sample 7 | HSQ 2 AR | 2.00% | 0.11% | 20:1 | 114.1 | 94.7 |
| Sample 8 | HSQ 3 AR | 0.20% | 0.12% | 2:1 | 113.1 | 82.7 |

The abrasion resistance was tested by use of a Linear Taber Abrader (Model 5750, available from Taber Industries, North Tonawanda, N.Y.), using a cylindrical tip with a radius of 2 cm, affixed with 4 layers of cheesecloth wrap (Crockmeter Squares for American Standards, 200877, available from SDL Atlas USA, Rock Hill, S.C.) and with a constant load of 750 g.

The traditional lack of ETC durability on AR coated surfaces is consistent with lowered reactivity or number of functional groups on the SiO₂ top coat or perhaps other differences, whether topographical or bulk material properties (such as modulus). Whereas neither Sample 6 (the control) nor the HSQ coatings, Samples 7 and 8, retain water contact angles above 100, there was still a marked improvement of the HSQ formulation (in particular, higher HSQ content) in Samples 7 and 8.

### Example 3: HSQ Cure Temperature Study

Samples 9-13 were 2 step coatings with activation of the HSQ (FOx-25, available from Dow Chemicals, Midland, Mich.) coating after cure, in addition to the necessary degree of cure for HSQ not yet explored in the above Samples 1-8. Each sample 9-13 included ETC and HSQ on AR (MFA2 AR3.0) coated glass. Sister samples of HSQ (25 wt. %) that were spun coat onto AR coatings on glass were cured at a range of temperatures, from no cure (Sample 9), 130° C. (Sample 10), 240° C. (Sample 11), 300° C. (Sample 12), and 400° C. (Sample 13).

The HSQ coatings were treated with an oxygen plasma to oxidize the Si—H groups to Si—OH, to enable reaction with trialkoxy (or acetoxy, etc.) silane terminated perfluoropolyethers. These surface activated HSQ coatings, alongside a no HSQ control, were spray coated with ETC and cured (POR), then abrasion resistance tested with cheesecloth abrasion for 200 k cycles.

The abrasion resistance of Samples 9-13 was tested by use of a Linear Taber Abrader (Model 5750, available from Taber Industries, North Tonawanda, N.Y.), using a cylindrical tip with a radius of 2 cm, affixed with 4 layers of cheesecloth wrap (Crockmeter Squares for American Standards, 200877, available from SDL Atlas USA, Rock Hill, S.C.) and with a constant load of 750 g.

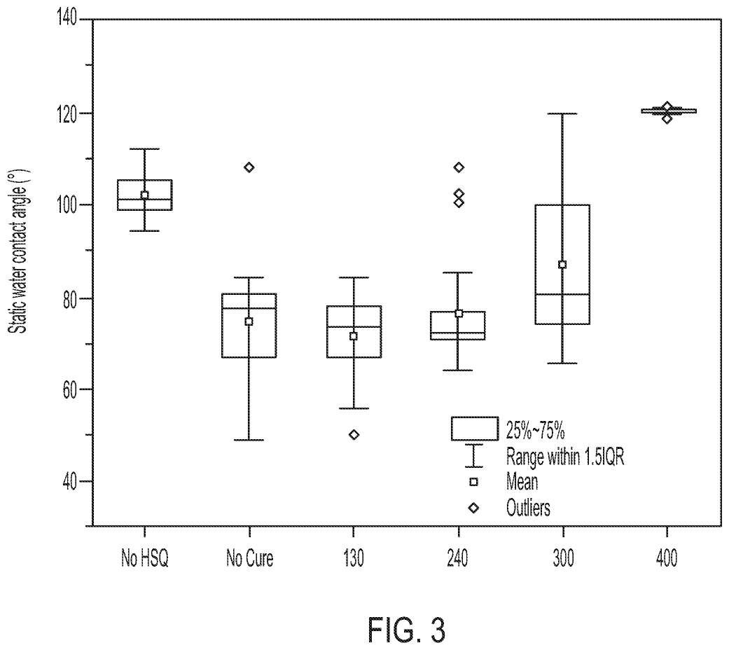

The results are shown in FIG. 3, where the static WCA of under cured HSQ Samples 9-12 (no cure, 130, 240, 300) were below 100 after abrasion while the control hovered around 100 with a distribution of +/−10. Samples 13 (the 400 C cure HSQ) had a tight distribution of 120 WCA.

### Example 4: Durability Performance as a Function of HSQ Coating Thickness

In a co-mixed condition as described with reference to Samples 9-13, it was expected that the Samples would contain a reservoir of ETC beneath the top surface. However, to test the hard-coat or other advantages of HSQ, such as potential increased surface area or reactive groups, a thickness study was conducted.

Samples 14-17 contained ETC and HSQ (FOx-25, available from Dow Chemicals, Midland, Mich.) on AR (MFA2 AR3.0) coated glass. In Samples 14-17, HSQ was serially diluted from 25% (as received, Sample 14), and ten and hundred-fold dilutions of 2.5% (Sample 15) and 0.25% (Sample 16), as well as 1% (Sample 17). The Samples 14-17 were all cured at 400° C. for 30 minutes, plasma treated to active the surface, and spray coated with ETC, then the coating was abrasion resistance tested with cheesecloth abrasion for 200 k cycles.

The abrasion resistance of Samples 9-13 was tested by use of a Linear Taber Abrader (Model 5750, available from Taber Industries, North Tonawanda, N.Y.), using a cylindrical tip with a radius of 2 cm, affixed with 4 layers of cheesecloth wrap (Crockmeter Squares for American Standards, 200877, available from SDL Atlas USA, Rock Hill, S.C.) and with a constant load of 750 g.

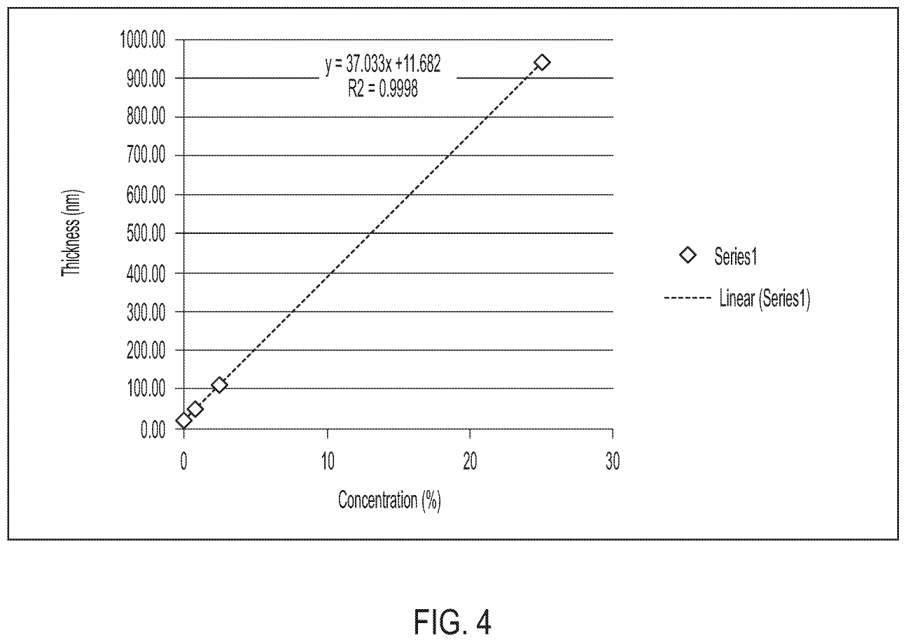

A duplicate of each Sample 14-17 was made on silicon wafers to quantify film thickness (FIG. 4) and refractive index, and subsequently the film porosity (see Table 3 below). From the film thickness measurements, the 25%, 2.5%, 1% and 0.25% corresponds to ˜1 μm, 100 nm, 50 nm and 15 nm.

TABLE 3
HSQ layer thickness as a function of spin coating.

| | Concentration | Thickness | | |
|---|---|---|---|---|
| | (%) | (nm) | n550 | Porosity (%) |
| Sample 14 | 25 | 936.86 | 1.363 | 21.3 |
| Sample 15 | 2.5 | 111.89 | 1.368 | 20.2 |
| Sample 16 | 1 | 46.85 | 1.383 | 17.1 |
| Sample 17 | 0.25 | 15.81 | 1.325 | 29.2 |

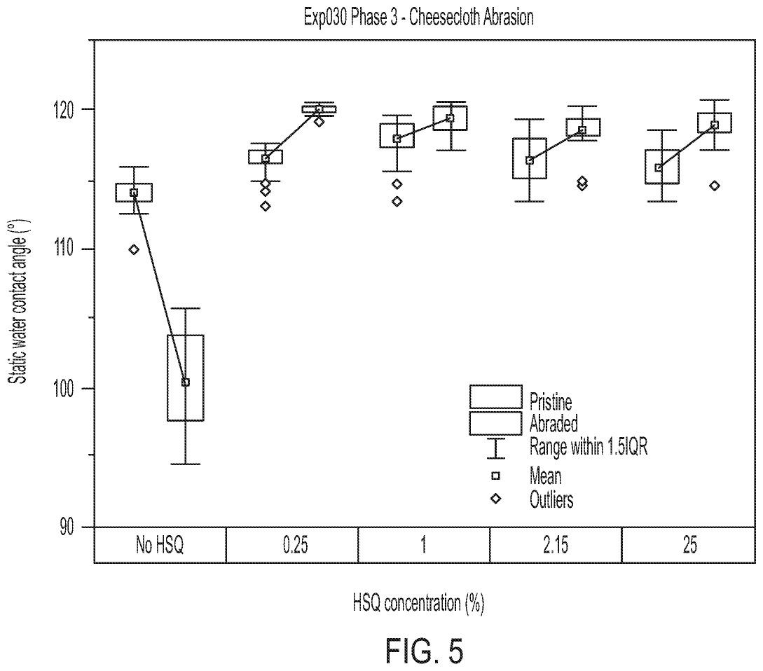

The results showed that the abrasion resistance was similar for all the HSQ concentrations tested in Samples 14-17 as graphed in FIG. 5. While the Samples 14-17 starting points water contact angle (WCA) were similar, the HSQ based Samples 14-17 of all thicknesses resulted in a slightly elevated WCA. This is typical of minor abrasion/rearrangement of ETC-type coatings. Samples 15-17 had a much distribution and consistency than Sample 14 (the ETC control).

### Example 5: HSQ Formulation with Decreased Cure Temperature

For cost reasons or applications where there can be temperature sensitive components, a 400+° C. temperature cure can be prohibitive. HSQ contains reactive sites that, once activated, can react with both the substrate surface as well as the ETC to create a network forming properties to build mechanical strength. Sample 18 exhibited activation of these sites without high temperature curing.

In Samples 9-13, the HSQ network was formed (and bonded to the substrate) by thermal treatment utilizing a bond rearrangement mechanism afforded by the high temperature. This thermally cured film was then followed by oxygen plasma to oxidize the Si—H bonds, rendering them active (Si—OH).

Sample 18 exhibited an alternative path to achieve the same end result. Sample 18 included ETC and HSQ (FOx-25, available from Dow Chemicals, Midland, Mich.) on AR (MFA2 AR3.0) coated glass. However, utilizing amine catalysis in the presence of water, the Si—H groups of HSQ were converted first to a cage terminated by silanol groups. Subsequently, the silanol groups were condensed into a network at modest temperatures (between about 100° C. to 200° C.). The silanol condensation reaction was accelerated by removal of water as it was generated. Furthermore, the lowered cure temperature allowed co-mixing with organic materials (such as ETC type fluorinated silanes) and curing in a single step. Alternatively, the same strategies from Samples 9-17 could be used.

In Samples 9-13, an HSQ precursor such as trimethoxysilane could be used in place of HSQ, to form an oligomeric Si—O—Si network without gelation. A pre-oligomerized version could be used compared to sol-gel precursors such as TEOS (tetraethyl orthosilicate) or TMOS (tetramethyl orthosilicate) or alkyl functionalized such as alkyltrialkoxysilanes, due to the higher shrinkage of the resulting network and lowered film mechanical strength due to the higher porosity and film strain.

### Example 6: HSQ Formulation with Fluorine Containing Compound

Fluorine containing compounds that are not of the perfluoroether type (such as a cyclic structure or Cytop® available from AGC Chemicals Americas, Inc., Exton, Pa.), have higher temperature stability and potentially hydrolytic stability. In applications where hydrolytic stability are necessary, materials that are more hydrolytically stable and more temperature stable can be used. The higher temperature stability would enhance the durability not only in inherent material properties, but also could enable enhanced cure using the silsesquioxane and therefore, higher crosslink density.

### Example 7: HSQ Formulation with Refractive Index Adjustment

The multifunctional siloxane resin can be formulated based on a desired refractive index, dependent on the anti-reflective (AR) coating on the substrate. In this case, the multifunctional siloxane resin could, for example, have a refractive index (RI) of from about 1.3 to about 1.5. This would change AR coating performance.

### Example 8: Formulation with Other Resins

Other silane or alcohol reactive multifunctional crosslinkers can also be utilized, depending on durability and pencil hardness required for the specific application. Some examples include multifunctional epoxy, whether reinforced with particles (silica, alumina, etc.) or fibers (glass, cellulose, etc.). Multifunctional epoxy can include, for example, high-functionality epoxy phenol novolac (EPN) and epoxy cresol novolac (ECN) resins available from Huntsman®.

An alternative resin could be used with the ETC coating, including other multifunctional siloxane resins, such as multiply branched, difunctional or T-resins or Q-resins type (tri or tetra functional) siloxanes and preceramic polymers such as polysilazanes, or thermally or UV labile polysilsesquioxanes (such as for example poly(2-acetoxyethylsilsesquioxane) for thermal, and pol(2-Bromoethylsilsesquioxane) for UV). Other “cage” type resins with POSS structure, such as acrylic, methacrylic, or vinyl functionalized cases with similar structure to HSQ could be used.

### Example 9: Formulation with Incorporation of Additives

Other additives could optionally be incorporated to enhance or otherwise tune the properties of the ETC coating, whether mechanical or optical. For example, a UV stabilizer which work either as a UV absorber or HALS (hindered amine light stabilizers) can be incorporated to improve the UV performance. Likewise, optical brightener could potentially be used to make a surface appear brighter or whiter, or other dyes, pigments, absorbers can be used to shift the color or tone of the substrate.

### Example 10: Samples with Plasma Cure Step

In Example 10, the process we used for modifying a substrate surface with polysiloxane started with substrate preparation. The substrates tested were a Maxwell glass ceramic.

The glass or ceramic substrate was cleaned using a detergent wash in an ultrasonic bath. The detergent included Alconox detergent (Alconox Inc. White Plains, N.Y.), pH of 9.5, for about 5 minutes, at 55 degrees Celsius, with ultrasonics. The substrate was then rinsed and dried, using a method that would not add molecular organic contamination to the surface of substrate. Drying methods included blowing with clean dry air or nitrogen gas. Next, an oxygen plasma was added to the substrate for further cleaning at about three minutes in vacuum. The plasma was a Harrick cleaner (Harrick Plasma, Ithaca, N.Y.).

The liquid polysiloxane film was then applied to the cleaned surface of the substrate. The liquid polysiloxane was T11 211 (Honeywell, Charlotte, N.C.). The thickness of the polysiloxane film was adjusted through modification using 6.5 v/v % of the liquid polysiloxane in isopropyl alcohol at a spin speed of 3,000 rpm for about 30 seconds.

Subsequently, the substrate with the applied polysiloxane was cured. The article was exposed to atmospheric pressure plasma (“AP plasma”) using argon and oxygen at the appropriate dosage. The plasma exposure was done at speeds from 0.2 to 1.65 mm/s. Doses used 201 pm argon and 0.31 pm oxygen, with a 4 mm working distance and a 1 mm linear nozzle. Comparative examples were done with thermal exposure, including oven heating at 435 degrees Celsius for an hour (as recommended by manufacturer of the liquid polysiloxane).

After curing of the polysiloxane, the ETC coating was applied. The ETC was a silane-perfluoropolyether (“PFPE”). This was applied by dip coating the substrate in a UD509 solution (Daikin, Houston, Tex.) at 0.12% in Novec 7200 solvent (3M, St. Paul, Minn.). A fast manual withdrawal speed was used to enable thicker films, due to autophobic de-wetting. Next, the ETC coating was cured. The coated substrate was placed in an oven for about 30 minutes at about 150 degrees Celsius.

Finally, excess ETC was removed, such as by 5 minutes of ultrasonic rinse in water or a solvent such as Novec 7200 (3M, St. Paul, Minn.). All droplets of excess ETC were removed and checked at 500× magnification using laser confocal or optical microscopy. Removal allowed reduction of haze and for checking of abrasion data unbiased by excess ETC.

### Example 11: Durability, Contact Angle, and Film Thickness Testing

The samples from Example 10 were tested for durability with steelwool abrasion followed by water contact angle measurements. The samples were first abraded using steelwool (Bonstar Grade 0000, Japan) to desired number of cycles on a linear reciprocal abrader (Proyes PAT-2012, Taiwan). The abrasion conditions include 1 kg of total applied weight, on a 1.5-inch-long track at 60 cycles/min. The orientation of the steelwool fibers was aligned in the same direction of the abrasion. Two tracks were abraded on each sample.

The water contact angle was subsequently measured on the abraded regions. Water contact angle was measured on a drop shape analyzer (Kruss DSA100, Germany) using high purity de-ionized water (18 megOhm at 22° C.). Spherical fit was used to extract the angle between the interface of the water drop and the sample surface. A total of five locations were measured diagonally along the track. Water contact angle normally drops as a function of abrasion cycles. A lower drop rate indicates the surface remains hydrophobic and the ETC coating is still functional. On the other hand, a higher drop rate indicates the low durability of ETC coating.

The abrasion was initially stopped after every 200 cycles to carry out the measurement of the contact angle, up to 1000 cumulative cycles. After that, samples were measured every 1000 cycles until either the total number of cycles reaching 8000, or the average water contact angle out of the five measurements drops below 80 degrees. The frequency of contact angle measurement was high in the beginning stage of abrasion, because pre-mature failure of ETC on earlier samples was reported with the water contact angle dropping to ˜80 degrees after a total of 400 to 600 cycles.

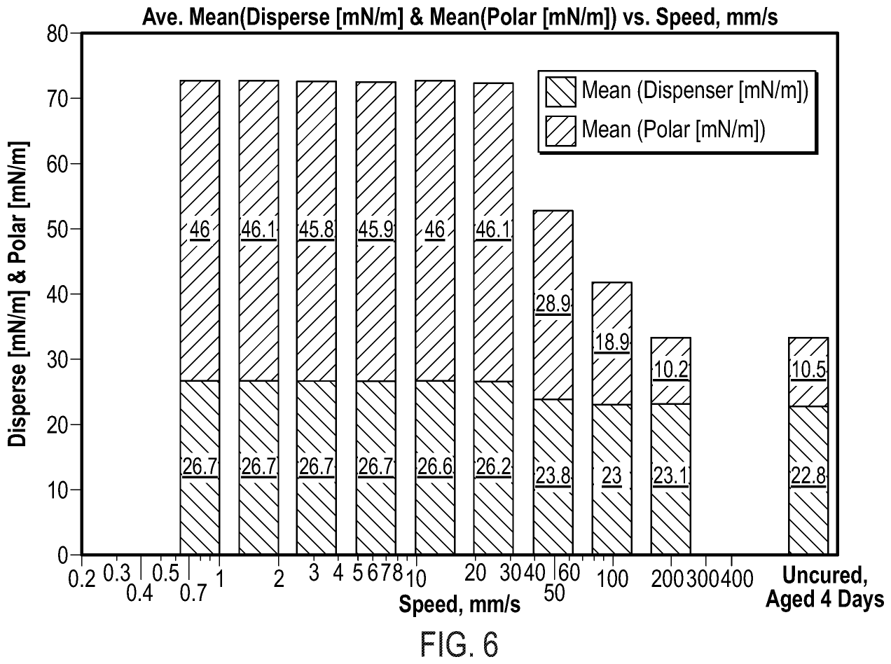

Failure was defined when average water contact angle out of the five locations was below 100 degrees. FIG. 6 depicts three examples of ETC degradation measured by water contact angle as a function of steelwool abrasion cycles. The three samples in this example were all cleaned using 3% Semiclean KG detergent at 55° C. for different durations. The time for sample MGC101 was 2 min, 5 min, and 8 min were used for sample MGC104 and sample MGC107, respectively. The results showed the impact of cleaning time on the steelwool performance. Longer duration was detrimental for the ETC durability.

Film thickness was determined by ellipsometry of films on silicon wafers treated in the same fashion as glass ceramic substrates, using 1.39 as the refractive index for the coating.

### Example 12: Surface Free Energy of Polysiloxane Film

Surface free energy of plasma treated polysiloxane films was studied for the samples from Example 10. Control of surface polarity and surface free energy using AP plasma was demonstrated by first applying 20 nm thin films of liquid polysiloxane was T11 211 (Honeywell, Charlotte, N.C.) to several samples and then plasma treating them. The samples were made by spin coating a 6.5% solution of the liquid polysiloxane v/v on glass at 3,000 rpm.

These films were subjected to various doses of AP plasma using a SurfX AF500 (Surfx Technologies LLC, Redondo Beach, Calif.) at 160 W, 20 lpm argon, 0.3 lpm oxygen, with a 4 mm working distance. The 1″ linear nozzle was passed over the sample at speeds from 0.8 to 200 mm/s. After plasma exposure, surface free energy (“SFE”) was measured using water and hexadecane and a Kruss DSA100 goniometer (Kruss Scientific, Hamburg, Germany). SFE components, both polar and dispersive, were calculated using the Owens, Wendt, Rabel and Kaelble (OWRK) method.

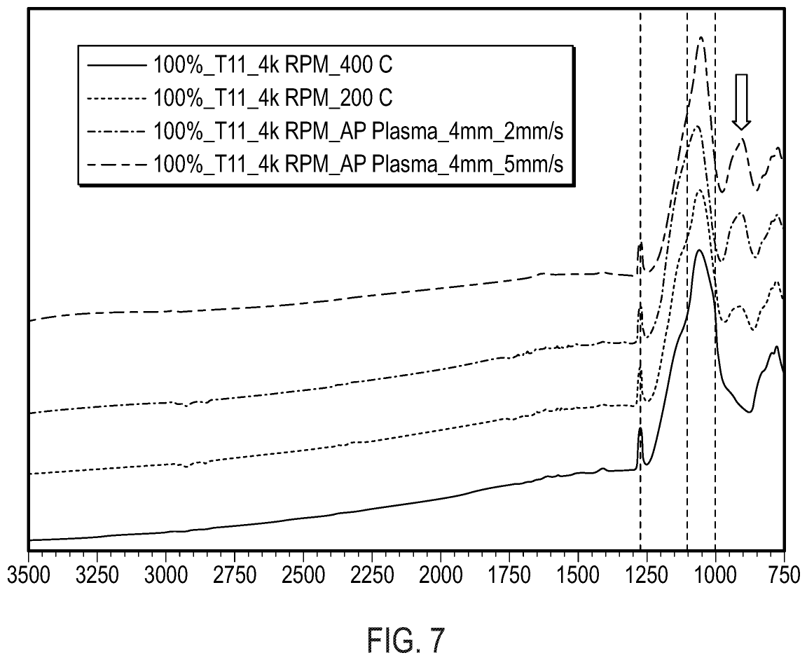

FIG. 7 depicts the surface free energy versus AP plasma speed for a the polysiloxane thin films exposed to AP plasma at various speeds. Polar component of surface free energy was modified stepwise from 10.5 to 46 mN/m by changing plasma dose, indicating the top surface of the polysiloxane film can be modified to have more or less Si—OH (silanol) surface groups.

### Example 13: Plasma Cure of Polysiloxane Film

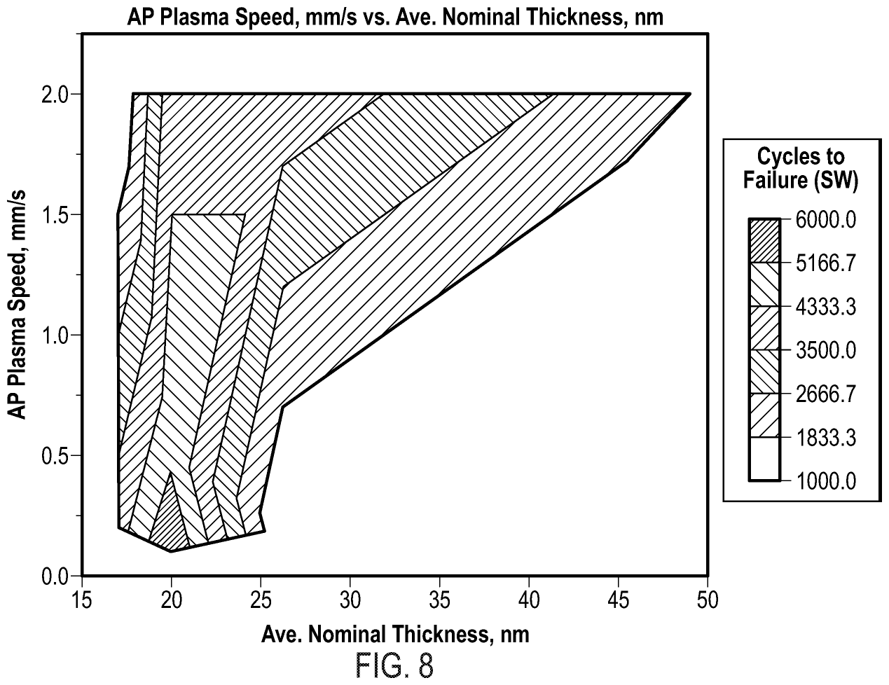

Example 13 includes a comparison of sample siloxane primer films cured with AP plasma and thermally cured, prepared as discussed in Example 10. ATR-FTIR analysis of siloxane primer films (on SiO2 wafers) which were thermally cured vs. cured using AP plasma show differences in reflectance spectra. FIG. 8 has an arrow pointing to a peak at ˜925 wavenumber which is not present on fully cured siloxane primer films (at 400 degrees Celsius). This peak is not present on fully cured films and is present in films cured at 200 degrees Celsius, and at higher levels for AP plasma cured films. The ˜925 wavenumber peak can represent Si—OH bonds. This indicates changes in the bulk film with and AP plasma cure, which can account for film stability during abrasion.

### Example 14: ETC Durability

Example 14 depicts ETC durability, as tested by steel wool abrasion as described above. A significant increase in ETC durability was seen for MGC samples with siloxane primer films compared with equivalently washed samples without siloxane primer films, as shown below is Table 4.

TABLE 4
ETC durability tests.

| | | | Nominal | | Thermal | | | Steel Wood |
|---|---|---|---|---|---|---|---|---|
| | | | Thickness | | Cure 1 hr | Plasma | | abrasion |
| | | | ofT11 | | @ Temp | Speed | ETC | cycles to |
| | Detergent | Primer | (nm) | Cure | (C.) | (mm/s) | Application | failure |
| MGC | Alconox | T11 | 20 | 425 C./ | 425 | NA | Immersion | 100 |
| IOX 158 | | | | 1 hr | | | | |
| MGC | Alconox | T11 | 20 | AP | NA | 2 | Immersion | >8000 |
| IOX 160 | | | | Plasma | | | | |
| MGC | Alconox | T11 | 20 | AP | NA | 0.5 | Immersion | >8000 |
| IOX 162 | | | | Plasma | | | | |
| MGC | Alconox | T11 | 20 | AP | NA | 0.1 | Immersion | 6000 |
| IOX 164 | | | | Plasma | | | | |
| MGC | Alconox | None | NA | NA | NA | NA | Immersion | 100 |
| IOX 166 | | | | | | | | |
| MGC | Alconox | SiO2 | NA | NA | NA | NA | PVD | 200 |
| IOX 167 | | | | | | | | |
| MGC | Semiclean | T11 | NA | NA | NA | NA | Immersion | <100 |
| IOX 13 | KG | | | | | | | |
| MGC | Semiclean | T11 | 17.05 | AP | NA | 2 | Immersion | 1000 |
| IOX 25 | KG | | | Plasma | | | | |
| MGC | Semiclean | T11 | 17.05 | AP | NA | 0.2 | Immersion | 4000 |
| IOX 26 | KG | | | Plasma | | | | |
| MGC | Semiclean | T11 | 20 | 425 C./ | 425 | NA | Immersion | 100 |
| IOX 150 | KG | | | 1 hr | | | | |
| MGC | Semiclean | T11 | 20 | AP | NA | 2 | Immersion | 4000 |
| IOX 152 | KG | | | Plasma | | | | |
| MGC | Semiclean | T11 | 20 | AP | NA | 0.5 | Immersion | 5000 |
| IOX 154 | KG | | | Plasma | | | | |
| MGC | Semiclean | T11 | 20 | AP | NA | 0.1 | Immersion | 6000 |
| IOX 156 | KG | | | Plasma | | | | |
| MGC | Semiclean | T11 | 26.32 | AP | NA | 2 | Immersion | 4000 |
| IOX 27 | KG | | | Plasma | | | | |
| MGC | Semiclean | T11 | 26.32 | AP | NA | 0.2 | Immersion | 1000 |
| IOX 28 | KG | | | Plasma | | | | |
| MGC | Semiclean | T11 | 49.1 | 200 C./ | 200 | NA | Immersion | <100 |
| IOX 4 | KG | | | 1 hr | | | | |
| MGC | Semiclean | T11 | 49.1 | 425 C./ | 425 | NA | Immersion | 3000 |
| IOX 5 | KG | | | 1 hr | | | | |
| MGC | Semiclean | T11 | 49.1 | AP | NA | 2 | Immersion | 2000 |
| IOX 6 | KG | | | Plasma | | | | |
| MGC | Semiclean | T11 | 302.98 | 425 C./ | 425 | NA | Immersion | 200 |
| IOX 29 | KG | | | 1 hr | | | | |

Two samples (sample 166 and sample 3) were washed in Alconox detergent and Semiclean detergent, respectively and had cycles to failure (CTF) of 100 and 50, respectively. With a siloxane primer film, equivalent samples survived with greater than 8000 CTF for Alconox washed, and up to 6000 CTF for Semiclean washed samples. AP plasma treated samples had higher durability compared with thermal cured.

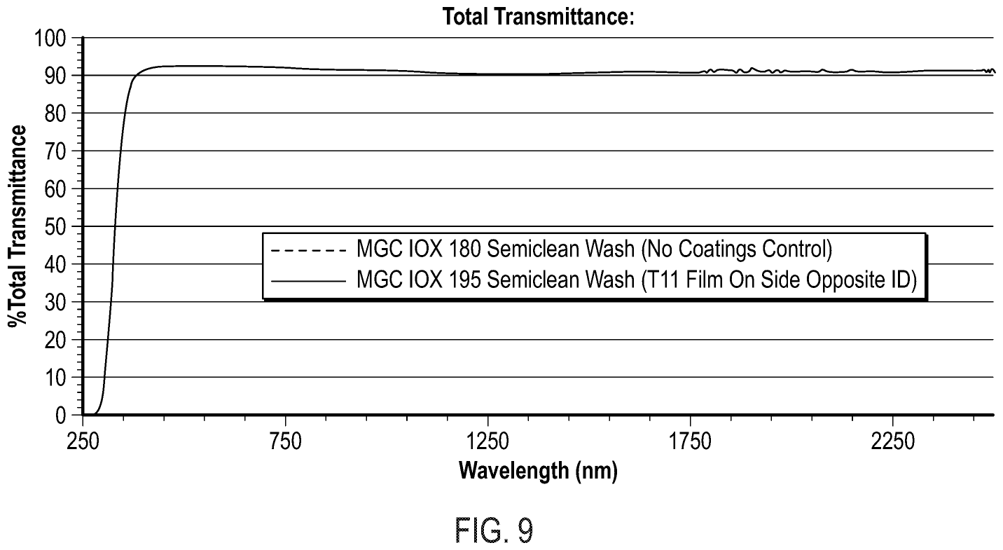

FIG. 9 depicts FTIR-ATR data of siloxane primer films cured at different temperatures for 30 minutes and cured using atmospheric plasma at different speeds. The effect of siloxane primer films is seen in the Semiclean washed MGC samples in Table 1, by plotting plasma speed (dose) vs. nominal thickness, shown in FIG. 9. Plasma treating done at speeds between 0.2-1.65 mm/s resulted in a thickness of about 20 nm.

As a comparative example, MGC washed in Alconox was submitted for application of vacuum deposited SiO2 thin film followed by ETC at CTCK (sample MGC IOX 167), and tested by steel wool abrasion. The cycles to failure for this sample was 200. This shows a significant loss in ETC durability vs. equivalently washed samples with AP plasma cured T11 primer (160, 162, 164).

### Example 15: Transmission of Films

In Example 15, the transmission of siloxane primer films was tested. A sample of substrate was coated with T11 to form a 20 nm thick film and the film was cured using AP plasma. This sample was compared with an uncoated sample for percent transmission at UV/Vis wavelengths and found to be unchanged, shown in FIG. 10. Percent haze was determined to be 0.08% for these same samples.

### Example 16: Alternative Substrates

Additional substrates were tested, including application of siloxane primer films and ETC coatings to an AR coated glass substrate, and quartz (fused silica).

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed can be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides an article comprising a substrate and a coating thereon comprising a functionalized fluorine containing compound crosslinked with a multifunctional siloxane resin.

Embodiment 2 provides the article of Embodiment 1, wherein the functionalized fluorine containing compound is a fluoroether silane.

Embodiment 3 provides the article of Embodiment 2, wherein the functionalized fluorine containing compound is a perfluoroether silane.

Embodiment 4 provides the article of any one of Embodiments 1 through 3, wherein the functionalized fluorine containing compound comprises one or more functional groups crosslinked with the multifunctional siloxane resin.

Embodiment 5 provides the article of any one of Embodiments 1 through 4, wherein the functionalized fluorine containing compound is an easy-to-clean coating.

Embodiment 6 provides the article of any one of Embodiments 1 through 5, wherein the multifunctional siloxane resin is a silsesquioxane.

Embodiment 7 provides the article of Embodiment 6, wherein the multifunctional siloxane resin comprises at least 60 mole % of [R²SiO_{3/2}] siloxy units wherein each R² is independently a C₁ to C₂₀ hydrocarbyl.

Embodiment 8 provides the article of Embodiment 7, wherein the multifunctional siloxane resin comprises at least 70 mole % of [R²SiO_{3/2}] siloxy units.

Embodiment 9 provides the article of Embodiment 8, wherein the multifunctional siloxane resin comprises at least 80 mole % of [R²SiO_{3/2}] siloxy units.

Embodiment 10 provides the article of any of Embodiments 7-9, wherein R² comprises an aryl group, an alkyl group, or combinations thereof.

Embodiment 11 provides the article of Embodiment 6, wherein the multifunctional siloxane resin comprises M siloxy units, D siloxy units, Q siloxy units, or combinations thereof.

Embodiment 12 provides the article of Embodiment 6, wherein the average molecular weight of the multifunctional siloxane resin is from about 1,000 g/mole to about 10,000 g/mole.

Embodiment 13 provides the article of Embodiment 12, wherein the average molecular weight of the multifunctional siloxane resin is from about 1,500 g/mole to about 5,000 g/mole.

Embodiment 14 provides the article of Embodiment 6, wherein the multifunctional siloxane further comprises one or more hydrolyzable groups.

Embodiment 15 provides the article of Embodiment 14, wherein the one or more hydrolyzable groups each comprise hydrogen, an alkyl group, an oximo group, an epoxy group, a carboxy group, an amino group, an amido group, or combinations thereof.

Embodiment 16 provides the article of any one of Embodiments 1 through 15, wherein the multifunctional siloxane resin is hydrogen silsesquioxane.

Embodiment 17 provides the article of any one of Embodiments 1 through 16, wherein the multifunctional siloxane resin is a multifunctional siloxane resin having silanol functionalities.

Embodiment 18 provides the article of any one of Embodiments 1 through 17, wherein the multifunctional siloxane resin is a multifunctional siloxane resin having hydroxyl functionalities.

Embodiment 19 provides the article of any one of Embodiments 1 through 18, wherein the functionalized fluorine containing compound comprises two or more layers.

Embodiment 20 provides the article of Embodiment 19, wherein the two or more layers are crosslinked.

Embodiment 21 provides the article of any one of Embodiments 1 through 20, further comprising light stabilizer.

Embodiment 22 provides the article of Embodiment 21, wherein the light stabilizer increases resistance of the coating to UV degradation.

Embodiment 23 provides the article of any one of Embodiments 1 through 22, wherein the coating has a thickness of between about 15 nm and about 100 nm.

Embodiment 24 provides the article of any one of Embodiments 1 through 23, wherein the substrate is a chemically strengthened glass.

Embodiment 25 provides the article of any one of Embodiments 1 through 24, wherein the substrate further comprises an anti-reflective coating.

Embodiment 26 provides the article of any one of Embodiments 1 through 25, wherein the coating has a water contact angle of above 100.

Embodiment 27 provides the article of any one of Embodiments 1 through 26, wherein the coating has a water contact angle in a range of about 90 degrees to about 130 degrees after 200,000 cycles cheesecloth testing.

Embodiment 28 provides the article of any one of Embodiments 1 through 27, wherein the coating has a water contact angle in a range of about 90 degrees to about 120 degrees after 3000 cycles steel wool testing.

Embodiment 29 provides the article of any one of Embodiments 1 through 28, wherein the coating has a porosity of about 0.10% to about 30.00%.

Embodiment 30 provides the article of Embodiment 29, wherein the coating has a porosity of about 0.10% to about 15.00%.

Embodiment 31 provides the article of any one of Embodiments 1 through 30, wherein the multifunctional siloxane resin is from about 0.01 wt % to about 25 wt. % of the coating.

Embodiment 32 provides the article of Embodiment 31, wherein the multifunctional siloxane resin is from about 0.025 wt. % and 0.25 wt. % of the coating.

Embodiment 33 provides the article of Embodiment 1, wherein the multifunctional siloxane resin has as surface free energy of about 10.5 to about 46 mN/m.

Embodiment 34 provides the article of Embodiment 1, wherein the multifunctional siloxane resin comprises a thickness of about 15 nm to about 50 nm.

Embodiment 35 provides the article of Embodiment 1, wherein the multifunctional siloxane resin comprises a thickness of about 17 nm to about 26 nm.

Embodiment 36 provides a method of making an article, comprising applying a multifunctional siloxane resin to a substrate, applying a functionalized fluorine containing compound to the substrate, and annealing the multifunctional siloxane resin and the functionalized fluorine containing compound.

Embodiment 37 provides the method of Embodiment 36, wherein annealing the coating at a temperature of about 300 degrees Celsius to about 500 degrees Celsius.

Embodiment 38 provides the method of Embodiment 36, wherein annealing the coating at a temperature of about 350 degrees Celsius to about 450 degrees Celsius.

Embodiment 39 provides the method of any one of Embodiments 36 through 38, wherein applying the multifunctional siloxane resin to the substrate comprises spin coating a thin layer onto the substrate.

Embodiment 40 provides the method of any one of Embodiments 36 through 39, wherein applying the multifunctional siloxane resin to the substrate comprises chemical vapor deposition or evaporation of the multifunctional siloxane resin.

Embodiment 41 provides the method of any one of Embodiments 36 through 40, wherein applying the functionalized fluorine containing compound to the substrate comprises spray coating the substrate with the functionalized fluorine containing compound.

Embodiment 42 provides the method of any one of Embodiments 36 through 41, wherein applying the multifunctional siloxane resin and applying the functionalized fluorine containing compound are done simultaneously.

Embodiment 43 provides the method of Embodiment 42, wherein the multifunctional siloxane resin and the functionalized fluorine containing compound are mixed together in solution prior to application.

Embodiment 44 provides the method of any one of Embodiments 36 through 43, wherein applying the multifunctional siloxane resin and applying the functionalized fluorine containing compound are done sequentially.

Embodiment 45 provides the method of Embodiment 44, wherein applying the multifunctional siloxane resin is done prior to applying the functionalized fluorine containing compound.

Embodiment 46 provides the method of Embodiment 44, further comprising curing the multifunctional siloxane resin on the substrate prior to applying the functionalized fluorine containing compound.

Embodiment 47 provides the method of Embodiment 36, further comprising plasma treating the multifunctional siloxane resin.

Embodiment 48 provides the method of Embodiment 47, wherein plasma treating the multifunctional siloxane resin comprises oxidizing a majority of the multifunctional siloxane resin to stabilize the resin into a film.

Embodiment 49 provides the method of Embodiment 47 or 48, wherein plasma treating comprises application of a vacuum based plasma.

Embodiment 50 provides the method of any one of Embodiments 47-49, wherein plasma treating comprises application of an atmospheric pressure plasma.

Embodiment 51 provides the method of any one of Embodiments 47-50, wherein plasma treating comprises applying plasma at a speed of about 0.8 to about 200 mm/s.

Embodiment 52 provides the method of any one of Embodiments 47-51, wherein plasma treating comprises applying plasma at a working distance of about 4 mm.

Embodiment 53 provides the method of any one of Embodiments 47-52, wherein plasma treating comprises applying plasma with a nozzle of about 1 mm.

Embodiment 54 provides an article made by the method of any one of Embodiments 36 through 53.

Embodiment 55 provides an article comprising a substrate and a coating thereon comprising a functionalized fluorine containing compound crosslinked with a multifunctional siloxane resin, wherein the coating has a water contact angle in a range of about 90 degrees to about 130 degrees after 200,000 cycles cheesecloth testing.

Embodiment 55 provides an article comprising a substrate and a coating thereon comprising a functionalized fluorine containing compound crosslinked with a multifunctional siloxane resin, wherein the coating has a water contact angle in a range of about 90 degrees to about 120 degrees after 3000 cycles steel wool testing.

What is claimed is:

1. An article comprising:
a substrate; and
a coating thereon comprising a functionalized fluorine containing compound crosslinked with a multifunctional siloxane resin.

2. The article of claim 1, wherein the functionalized fluorine containing compound is a fluoroether silage.

3. (canceled)

4. The article of claim 1, wherein the functionalized fluorine containing compound comprises one or more functional groups crosslinked with the multifunctional siloxane resin.

5. (canceled)

6. The article of claim 1, wherein the multifunctional siloxane resin is a silsesquioxane.

7. The article of claim 6, wherein the multifunctional siloxane resin comprises at least 60 mole of [R²SiO_{3/2}] siloxy units wherein each R² is independently a C₁ to C₂₀ hydrocarbyl.

8. (canceled)

9. (canceled)

10. The article of claim 7, wherein R² comprises an aryl group, an alkyl group, or combinations thereof.

11. (canceled)

12. The article of claim 6, wherein the average molecular weight of the multifunctional siloxane resin is from about 1,000 g/mole to about 10,000 g/mole.

13. (canceled)

14. The article of claim 6, wherein the multifunctional siloxane further comprises one or more hydrolyzable groups, each of the one or more hydrolyzable groups comprising hydrogen, an alkyl group, an oximo group, an epoxy group, a carboxy group, an amino group, an amido group, or combinations thereof.

15. (canceled)

16. The article of claim 1, wherein the multifunctional siloxane resin comprises one or more of hydrogen silsesquioxane, a multifunctional siloxane resin having silanol functionalities, and a multifunctional siloxane resin having hydroxyl functionalities.

17. (canceled)

18. (canceled)

19. (canceled)

20. (canceled)

21. (canceled)

22. (canceled)

23. (canceled)

24. (canceled)

25. The article of claim 1, wherein the substrate further comprises an anti-reflective coating.

26. (canceled)

27. The article of claim 1, wherein the coating has a water contact angle in a range of about 90 degrees to about 130 degrees after 200,000 cycles cheesecloth testing.

28. (canceled)

29. The article of claim 1, wherein the coating has a porosity of about 0.10% to about 30.00%.

30. (canceled)

31. (canceled)

32. (canceled)

33. The article of claim 1, wherein the multifunctional siloxane resin has as surface free energy of about 10.5 to about 46 mN/m.

34. (canceled)

35. (canceled)

36. A method of making an article, comprising:
applying a multifunctional siloxane resin to a substrate;
applying a functionalized fluorine containing compound to the substrate; and
annealing the multifunctional siloxane resin and the functionalized fluorine containing compound.

37. (canceled)

38. (canceled)

39. The method of claim 36, wherein applying the multifunctional siloxane resin to the substrate comprises:
spin coating a thin layer onto the substrate,
chemical vapor deposition or evaporation of the multifunctional siloxane resin, or spray coating the substrate with the functionalized fluorine containing compound.

40. (canceled)

41. (canceled)

42. The method of claim 36, wherein applying the multifunctional siloxane resin and applying the functionalized fluorine containing compound are done simultaneously.

43. (canceled)

44. The method of claim 36 wherein applying the multifunctional siloxane resin and applying the functionalized fluorine containing compound are done sequentially.

45. (canceled)

46. The method of claim 44, further comprising curing the multifunctional siloxane resin on the substrate prior to applying the functionalized fluorine containing compound.

47. The method of claim 36, further comprising plasma treating the multifunctional siloxane resin wherein the plasma treating comprising one or more of:
oxidizing a majority of the multifunctional siloxane resin to stabilize the resin into a film,
application of a vacuum based plasma,
application of an atmospheric pressure plasma,
applying plasma at a speed of about 0.8 to about 200 mm/s,
applying plasma at a working distance of about 4 mm, and
applying plasma with a nozzle of about 1 mm.

48. (canceled)

49. (canceled)

50. (canceled)

51. (canceled)

52. (canceled)

53. (canceled)

54. (canceled)

55. (canceled)

56. (canceled)

57. An article comprising:
a substrate; and
a coating thereon comprising a functionalized fluorine containing compound crosslinked with a multifunctional siloxane resin, wherein the coating has a water contact angle in a range of about 90 degrees to about 120 degrees after 3000 cycles steel wool testing.
